(19) United States
(12) Patent Application Publication
(10) Pub. No.: US 2020/0102496 A1
(43) Pub. Date: Apr. 2, 2020

(54) LIGHT-STORING FIBER WITH HIGH LUMINANCE

(71) Applicant: NAN YA PLASTICS CORPORATION, Taipei (TW)

(72) Inventors: TE-CHAO LIAO, TAIPEI (TW); CHUNG-CHI SU, TAIPEI (TW); Chia-Sheng Lai, TAIPEI (TW)

(21) Appl. No.: 16/585,590

(22) Filed: Sep. 27, 2019

(30) Foreign Application Priority Data
Sep. 27, 2018 (TW) 107134163

(51) Int. Cl. C09K 11/77; C09K 11/02; D01F 8/14; D01D 5/08; D01F 6/62

(52) U.S. Cl. CPC C09K 11/7792; C09K 11/02; D01F 6/62; D01D 5/08; D01F 8/14

(57) ABSTRACT

A high-luminance light-storing fiber is provided. A modified light-storing powder and a dispersing agent are added to a polyester material, and then prepared by kneading, granulating and spinning to obtain the light-storing fiber having fiber fineness of 1-10 dpf. The fiber luminance satisfies the following conditions: (1) after irradiation with a D65 light source at 2001 ux for 20 minutes, the initial luminance can reach 150 mcd/m2 or more; (2) after irradiation with a D65 light source at 251 ux for 25 minutes, the initial luminance can reach 50 mcd/m2 or more.

### CROSS-REFERENCE TO RELATED PATENT APPLICATION

This application claims the benefit of priority to Taiwan Patent Application No. 107134163, filed on Sep. 27, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE The present disclosure relates to a light-storing fiber, and more particularly to a light-storing fiber that can exhibit high luminance under low light conditions.

### BACKGROUND OF THE DISCLOSURE

In recent years, in order to improve the visibility of fabrics in the dark, fibers having light-storing properties have been widely used in various fields.

The principle of light-emitting of a light-storing material is to absorb visible light, ultraviolet light or sunlight by using a light-storing material, and after the light source is removed, an afterglow called phosphorescence can be emitted. Since the light-storing material is added into the fiber to make a light-storing fiber, the light-storing fiber does not need to be dyed, and can absorb visible light or solar light during the day to generate an electron energy level transition, and in the evening or in the dark, the fiber can emit afterglow of various colors, thereby improving visibility.

In the Japanese Patent Application No. S49-47646 and Japanese Patent Publication No. H3-70020, the light-storing fiber is a fiber produced by adding sulfide as a light-storing material. In the Japanese Patent Publication No. H112414, the main material of the composite light-storing fiber is zinc sulfide, and the above-mentioned fiber has the defects of weak luminance and short luminescence time. In order to improve the luminance effect, Japanese Patent Application No. H-10-231480 discloses a general formula of a light-storing material (M_{0.9995}Eu_{0.0005-0.002})Al₂O₄·(M_{0.9995}Eu_{0.0005-0.002})O·n(A_{1-b-a}B_{b}Qₐ)₂O₃, M may be at least one element of Sr, Ca, Mg and Ba, Q is at least at least one element of La, Ce, Pr, Nd, Sm, Gd, Tb, Dy, Ho, Er, Tm, Yb, Y, Lu, Mn, and Bi, a=0.0005-0.002, b=0.001-0.35, and n=1 to 8. In the Japanese Patent Application No. 2000-136438, a polyolefin fiber is produced by using a light-storing powder having such structure, and since the melting point of the polyolefin is 160° C., the polyolefin is prone to melting during the processing due to high temperature; under the specific gravity of <0.9, fine-denier fibers cannot be produced, and a problem that the fibers cannot be dyed may also be present.

Taiwan Patent No. 564268 discloses “highly bright luminous fiber and its producing method”, which uses a luminous powder obtained by a sintering method, and a powdered polyester resin or a polyolefin resin is used as a core-sheath type fiber core. The powder is added with a polyester resin or a polyolefin resin as a core-sheath type fiber core, the sheath portion is made of a polyester containing no luminescent powder, and the core-sheath type fiber core contains 7 to 25% of luminous powder, and is irradiated with 1000 LUX for 30 minutes. The luminance is recorded with time, 2 minutes after the irradiation is stopped, the luminance can reach 280mcd/m² or more, but after 10 minutes, the luminance decays to less than 80% thereof After 1 hour, the luminance is only 2.3 to % to 4.2% of the luminance after 2 minutes. Therefore, the decay rate of the light-storing fiber luminance is fast, and the percentage of residual luminance is low.

### SUMMARY OF THE DISCLOSURE

In response to the above-referenced technical inadequacies, the present disclosure provides a light-storing fiber.

In one aspect, the present disclosure provides a light-storing fiber with a fiber fineness of 1 to 10 dpf, which is produced by melt spinning with a light-storing masterbatch, especially a light-storing fiber which can exhibit a high-luminance under a low light condition (less than or equal to 2001 ux) and satisfies the following conditions:

(1) after irradiation with a D65 light source at 2001 ux for 20 minutes, the initial luminance can reach 150 mcd/m2 or more;

(2) after irradiation with a D65 light source at 25 LUX for 25 minutes, the initial luminance can reach 50 mcd/m2 or more. In one aspect, the present disclosure provides a light-storing masterbatch.

The total weight of the light-storing masterbatch includes 50% to 95% by weight of the thermoplastic (polymer) resin, 1% to 30% by weight of the modified light-storing powder, and 0.01% to 5% by weight of the antioxidant. After being modified, the modified light-storing powder can be uniformly dispersed in the resin to improve the binding of the modified light-storing powder to the resin modified. The light-storing masterbatch has a pressure rise value less than or equal to 0.5 bar/g. A spin-made light-storing fiber absorbs energy under low light conditions and exhibits characteristics of high-luminance and low luminance-decreasing rate in the dark.

The antioxidant of the present disclosure is selected from a hindered phenol type and phosphite type antioxidant, and preferably bis(2,6-di-tert-butyl-4-methylphenyl)pentaerythritol diphosphite.

In one aspect, the present disclosure provides a modified light-storing powder, which is an aluminate doped rare-earth element, and has the general formula M₁₋ₓAl₂O₄·Eu_{y}N_{z}, wherein M is Sr, Mg, Ca or Ba;

N is Td, Dy, La, Ce, Mn, Sm, Gd, Pr, Lu, Ho, Y, Yb, Tm or Er; and −0.33≤X≤0.6, 0.008≤Y≤0.002, 0.002≤Z≤0.005.

The modified light-storing powder of the present disclosure contains a silane coupling agent or a phthalate modifier added in an amount of 0.1% to 20% by weight based on the total amount of light-storing powder, and preferably contains 3-prop enyloxypropyltrimethoxysilane or pyrophosphate titanate in an amount of 1% to 10% by weight based on the total amount of the light-storing powder.

Therefore, the light-storing fiber of the present disclosure has the beneficial effect of exhibiting high luminance under low light conditions.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure provides a modified light-storing powder, which is an aluminate doped rare-earth element, and has the general formula M₁₋ₓAl₂O₄·Eu_{Y}N_{Z}, wherein M is Sr, Mg, Ca or Ba, N is Td, Dy, La, Ce, Mn, Sm, Gd, Pr, Lu, Ho, Y, Yb, Tm or Er and −0.33≤X≤0.6, 0.008≤Y≤0.002, 0.002≤Z≤0.005. The surface of the powder is modified by a powder surface modification technique, that is, using a modifier such as a silane coupling agent or a phthalate modifier added in an amount of 0.1% to 20% by weight based on the total amount of the light-storing powder, and preferably of 1% to 10% by weight based on the total amount of the light-storing powder.

The silane coupling agent of the present disclosure is selected from vinyl chloroform, vinyltrimethoxysilane,vinyl triethoxysilane, vinyltris(β-methoxyethoxy)silane, β-(3,4-epoxycyclohexypethyltrimethoxysilane, γ-(2-aza-propanering aminopropyltrimethoxysilane, γ-glycidoxypropyltrimethoxysilane,γ-glycidoxypropyltrimethyldiethoxysilane, γ-glycidoxypropyl triethoxy silane, γ-methacryl propyl methyl dimethoxy silane, γ-methyl propyl propyl trimethoxy silane, γ-methyl propyl propyl methyl diethoxy silane, γ-methacryl propyl triethoxy silane, n-β (aza-propyl) γ-aminopropyl methyl dimethoxy silane, n-β (aza-propyl) γ-aminopropyltrimethyloxysilane,n-β(aziridine)γ-aminopropyltriethoxysilane,3 -propenyloxypropyltrimethoxysilane,3-aminopropyltrimethoxysilane, 3-aminopropyltriethoxysilane,n-phenyl-γ-aminopropyltrimethoxysilane,γ-chloropropyltrimethoxysilane, γ-hydrothiopropyltrimethoxysilane, bis-(3-[triethoxynonyl]-propyl)-tetrasulfide (tespt) or bis-(3-[triethoxydecyl]propyl)-disulfide; preferably 3-propenylmethoxypropyltrimethoxy silane.

The titanate of the present disclosure is selected from isostearyl titanate, stearyl titanate, oleyl titanate and pyrophosphate titanate; preferably selected from pyrophosphate titanate.

The modification process of the light-storing powder of the present disclosure includes the following steps:

The light-storing powder is placed in a stirring tank and stirred at 200 rpm. The stirring blade is an anchor blade. The modifier 3-propyleneoxypropyltrimethoxydecane is taken by weight relative to the weight of the light-storing powder, diluted and dissolved with the volume ratio of modifier/isopropyl alcohol=1/6, and gradually added to the light-storing powder. A stirring rate of the blade is adjusted to 1000 rpm, and a dropping acceleration rate is 1 ml/min. After the completion of dropping addition, the stirring tank is heated to 120° C. and the light-storing powder is stirred for 2 hours to volatilize isopropyl alcohol to obtain a modified light-storing powder.

The method for preparing the light-storing masterbatch of the present disclosure includes the following steps:

Based on the total amount of the light-storing masterbatch, 1% to 30 wt % of the light-storing powder is taken, 50% to 95 wt % of a thermoplastic polymer is taken, and 0.01% to 5 wt % of an antioxidant is taken as raw materials. The thermoplastic polymer may be selected from polyester powder and polyester particles, and the polyester powder or particles have an intrinsic viscosity (IV) of 0.2 to 2.0, preferably 1.2. After the above raw materials are uniformly mixed into a mixed powder, the mixture is kneaded by a twin-screw extruder. The thermoplastic polymer (or resin) is molten at a kneading temperature of 180° C. to 280° C. and a rotation speed of 250 rpm. At this point, a terminal group of the modifier on the light-storing powder is excellent in compatibility with the resin, so that the light-storing powder is dispersed uniformly in the resin substrate. After cooling with water, pellets were dried at 140° C. for 4 to 6 hours to obtain the light-storing masterbatch of the present disclosure.

More specifically, the modified light-storing powder of the present disclosure is an inorganic material, and the powder is modified on the surface to be completely uniformly dispersed in the resin to improve dispersibility. Therefore, the light-storing masterbatch of the present disclosure has no pressure rise in a spinning process, has good spinning condition, and can be subjected to spinning production for a long time.

The antioxidant of the present disclosure may be selected from hindered phenol antioxidants and phosphite antioxidants.

The phosphite antioxidant may be selected from dimethyl 3,5-di-tert-butyl-4-hydroxybenzylphosphonate, 3,5 -di-tert-butyl-4-hydroxybenzylphosphonic acid diethyl ester, dipropyl 3,5-di-tert-butyl-4-hydroxybenzylphosphonate, dibutyl 3,5-di-tert-butyl-4-hydroxybenzylphosphonate, 3,5-di-tert dipentyl butyl-4-hydroxybenzylphosphonate, dihexyl 3,5-di-tert-butyl-4-hydroxybenzylphosphonate, 3,5-di-tert-butyl-4-hydroxybenzylphosphonic acid diheptyl ester, dioctyl 3,5-di-tert-butyl-4-hydroxybenzylphosphonate, bis(2,6-di-tert-butyl-4-methylphenyl)pentaerythritol diphosphite, double manganate of diethyl 3,5 -di-t-butyl-4-hydroxybenzyl)phosphonate, magnesium diethyl bis(3,5-di-t-butyl-4-hydroxybenzyl)phosphonate, bis(3,5-di-t-butyl-4-hydroxybenzyl)phosphonate calcate, and bis(3,5-di-t-butyl-4-hydroxybenzyl)phosphonic acid diethyl ester zincate; preferably bis(2,6-di-tert-butyl-4-methylphenyl)pentaerythritol diphosphite.

The light-storing fiber of the present disclosure is prepared by melt spinning a light-storing masterbatch after drying. Fiber structure of the light-storing fiber can be formed by composite spinning to form a core-sheath structure, the core is a light-storing masterbatch, the sheath is a polyester, and the core-sheath ratio (core/sheath) is varied, which is between 40/60 to 60/40.

The light-storing fiber manufacturing method of the present disclosure comprises the following steps:

The light-storing masterbatch of the present disclosure is taken as a raw material, at a spinning temperature of 230-290° C. and a spinning take-up speed of 1000-3000 m/min, partially oriented yarn (POY) of the core-sheath structure is formed by composite spinning, and drawn textured yarn (DTY) is formed by false twisting process, that is the light-storing fiber of the present disclosure. The light-storing fiber has a diameter of 10 to 30 micrometers (μm) and a fiber fineness of 1 to 10 dpf.

The light-storing fiber of the present disclosure has a fiber structure of a core-sheath design, and the core light-storing powder is wrapped in the core of the fiber, and after being washed for 50 times, the light luminance of the light-storing fiber can be maintained. Therefore, the light-storing fiber of the present disclosure can be widely applied to the fiber application industry, including clothing, home furnishings and outdoor safety products.

Hereinafter, a plurality of specific embodiments (embodiment 1 to 4) for producing modified light-storing powder and processing the modified light-storing powder into light-storing masterbatch and light-storing fiber are provided, and a comparative example is provided to help explain the purpose, efficacy and principle of the present disclosure.

The modified light-storing powder and light-storing fiber produced by each embodiment and the comparative example are evaluated for physical properties according to the following methods: 1. Pressure test: the light-storing masterbatch is diluted to 8% and the pressure rise thereof is evaluated by a filter tester (label: LabTech, model: LTF34-GP) with a screen pack size of 15 μm. The lower the pressure rise is, the better the dispersion of the light-storing powder in the polyester resin is.

2. Luminance test: according to JIS Z9107 as the standard, a sample garter diameter is 35 mm, the sample is placed in a black box, standing for 48 h, at temperature of 23±2° C., and RH of 50±10%. After being radiated with the D65 light source at 2001 ux for 20 min and 251 ux for 15 min, a test is performed with a luminance meter (label: KONICA MINOLTA model: LS-100), and luminance of 2, 10, 20, 30, and 60 minutes are recorded.

### First Embodiment

1. Light-storing powder modification: the light-storing powder is placed in a stirring tank, stirred at 200 rpm, and the stirring blade is anchored. The modifier 3-propyleneoxypropyltrimethoxydecane is taken 1% by weight relative to the weight of the light-storing powder, diluted and dissolved with the volume ratio of modifier/isopropyl alcohol=1/6, and gradually added to the light-storing powder. A blade stirring rate is adjusted to 1000 rpm, and a dropping acceleration rate is 1 ml/min. After the completion of dropping addition, the stirring tank is heated to 120° C. and stirred for 2 hours to volatilize isopropyl alcohol to obtain a modified light-storing powder.

2. Light-storing masterbatch production: according to raw material formula of Table 2, 79.5 wt % of PET polyester resin, 20 wt % of modified light-storing powder A1, and 0.5 wt % of bis(2,6-di-tert-butyl-4-methylphenyl)pentaerythritol diphosphite (hereinafter referred to as antioxidant RCPEP36) are taken as a raw material, and melt granulated by a twin-screw extruder.

3. Light-storing fiber production: Fiber specification is 75D/72F. A core is the light-storing masterbatch after drying, a sheath is dry polyester, a core-sheath ratio is 50/50, a spinning temperature is 280° C., and a spinning speed is 2500 m/min. The POY is produced, and processed into DTY, which is then woven into a garter.

The pressure rise value of the light-storing masterbatch prepared is tested, and the results are shown in Table 2. After the light-storing masterbatch is spun and woven, the test luminance is shown in Tables 3 and 4. After the garter has been washed for 50 times, the luminance test results are as shown in Table 5. The light-storing effect is maintained at the initial level, and the luminance of the yarn before and after washing has not been affected.

### Second Embodiment

1. A modified light-storing powder is prepared in the same method as in the embodiment 1, but the modifier is added in an amount of 5 wt % of the weight of the light-storing powder (Table 1, Formula No. A2).

2. According to raw material formula of Table 2, 79.5 wt % PET polyester resin, 20 wt % of modified light-storing powder A2, and 0.5 wt % antioxidant RCPEP36 are taken as a raw material, and melt granulated by a twin-screw extruder so as to obtain the light-storing masterbatch.

The pressure rise value of the light-storing masterbatch prepared is tested, and the results are shown in Table 2. After the light-storing masterbatch is spun and woven, the test luminance is shown in Tables 3 and 4. After the garter has been washed for 50 times, the luminance test results are as shown in Table 5. The light-storing effect is maintained at the initial level, and the luminance of the yarn before and after washing has not been affected.

### Third Embodiment

1. A modified light-storing powder is prepared in the same method as in the embodiment 1, but the modifier is added in an amount of 10 wt % of the weight of the light-storing powder (Table 1, Formula No. A3).

2. According to raw material formula of Table 2, 79.5 wt % PET polyester resin, 20 wt % modified light-storing powder A3, and 0.5 wt % of antioxidant RCPEP36 are taken as a raw material, and melt granulated by a twin-screw extruder so as to obtain the light-storing masterbatch.

The pressure rise value of the light-storing masterbatch prepared is tested, and the results are shown in Table 2. After the light-storing masterbatch is spun and woven, the test luminance is shown in Tables 3 and 4. After the garter has been washed for 50 times, the luminance test results are as shown in Table 5. The light-storing effect is maintained at the initial level, and the luminance of the yarn before and after washing has not been affected.

### Fourth Embodiment

1. A modified light-storing powder is prepared in the same method as in the embodiment 1, but the modifier is pyrophosphate titanate in an amount of 10 wt % of the weight of the light-storing powder (Table 1, Formula No. A4).

2. According to raw material formula of Table 2, 79.5 wt % PET polyester resin, 20 wt % of modified light-storing powder A4, and 0.5 wt % of antioxidant RCPEP36 are taken as a raw material, and melt granulated by a twin-screw extruder so as to obtain the light-storing masterbatch.

The pressure rise value of the light-storing masterbatch prepared is tested, and the results are shown in Table 2. After the light-storing masterbatch is spun and woven, the test luminance is shown in Tables 3 and 4. After the garter has been washed for 50 times, the luminance test results are as shown in Table 5. The light-storing effect is maintained at the initial level, and the luminance of the yarn before and after washing has not been affected.

### COMPARATIVE EXAMPLE

1. light-storing powder is not modified (Table 1, Formula No. A5)

2. According to raw material formula of Table 2, 79.5 wt % PET polyester resin, 20 wt % of modified light-storing powder A5, and 0.5 wt % of antioxidant RCPEP36 are taken as a raw material, and melt granulated by a twin-screw extruder so as to obtain the light-storing masterbatch.

The pressure rise value of the light-storing masterbatch prepared is tested, and the results are shown in Table 2. After the light-storing masterbatch is spun and woven, the test luminance is shown in Tables 3 and 4. After the garter has been washed for 50 times, the luminance test results are as shown in Table 5. The light-storing effect is maintained at the initial level, and the luminance of the yarn before and after washing has not been affected.

### Conclusion

1. The light-storing powder of embodiments1-3 is treated with the modifier 3-acryloxypropyltrimethoxydecane and the light-storing powder of embodiment4 is treated with the modifier pyrophosphate titanate, and then the resin and a dispersing agent are mixed and granulated, respectively. After the light-storing masterbatch is dried, the pressure rise value is evaluated by a filter tester, and the test value (as shown Table 2) is less than or equal to 0.5 bar/g. Therefore the light-storing powder is excellently dispersed in the polyester resin.

2. The light-storing powder of Comparative Example 1 is not modified, and is directly mixed with resin and dispersant. After the light-storing masterbatch is dried, the pressure rise is evaluated by a filter=tester. The test value (as shown Table 2) is 1.2 bar/g, greater than 0 5 bar/g. Therefore the light-storing powder is not well dispersed in the polyester resin.

3. The above two conclusions confirm that the light-storing powder treated by the modifier can effectively help the light-storing powder to be dispersed in the polyester resin, reduce the phenomenon of powder agglomeration, and improve the pressure rise, which helps the spinning process of the light-storing fiber to proceed smoothly.

4. Regarding the light-storing masterbatch produced by embodiments 1-4, after drying and removing water, fiber structure of the light-storing fiber can be formed by composite spinning to form a core-sheath structure, the core is a light-storing masterbatch, and the sheath is a polyester. After being coiled, the light-storing masterbatch is processed into drawn textured yarn, and the garter is evaluated. After the surface of the light-storing powder is modified, the yarn is spun and the luminance of the yarn is higher than that of the unmodified powder surface, as shown in Table 3. Under low light source, there is also the same result, as shown in Table 4.

5. After the spinning of embodiments 1-4 and comparative example 1, there is no change of the luminance of the yarn before and after the yarn being washed, since the yarn is made by composite spinning, and the light-storing powder is wrapped in the fiber center, so that the luminance of the yarn before and after being washed would not be affected, as shown in Table 5.

TABLE 1
modified light-storing powder formula

| Modified powder formula number | | | | | | | |
|---|---|---|---|---|---|---|---|
| Item | | Raw material (wt %) | A1 | A2 | A3 | A4 | A5 |
| modified | light- | SrAl₂O₄•Eu_{0.001}Dy_{0.003} | 99 | 95 | 90 | 99 | 100 |
| light- | storing | | | | | | |
| storing | powder | | | | | | |
| powder | Modifier | 3-propenyloxypropyl- | 1 | 5 | 10 | — | — |
| | | trimethoxysilane | | | | | |
| | | Pyrophosphate titanate | — | — | — | 1 | — |

TABLE 2
light-storing masterbatch formula (wt %) and pressure rise

| | | | | | | com- |
|---|---|---|---|---|---|---|
| | | | | | | parative |
| | Raw | Embodi- | Embodi- | Embodi- | Embodi- | example |
| Item | material | ment 1 | ment 2 | ment 3 | ment 4 | 1 |
| Polyester | PET(IV = | 79.5 | 79.5 | 79.5 | 79.5 | 79.5 |
| modified | 1.2) | | | | | |
| light- | A1 | 20 | — | — | — | — |
| storing | A2 | — | 20 | — | — | — |
| powder | A3 | — | — | 20 | — | — |
| | A4 | — | — | — | 20 | — |
| | A5 | — | — | — | — | 20 |
| Anti- | RC PEP | 0.5 | 0.5 | 0.5 | 0.5 | 0.5 |
| oxidant | 36^{* 1} | | | | | |
| Pressure | — | 0.4 | 0.1 | 0.002 | 0.5 | 1.2 |
| rise (bar/g) | | | | | | |

Note 1:
RC PEP 36 represents bis(2,6-di-tert-butyl-4-methylphenyl)pentaerythritol diphosphite.

TABLE 3
light-storing fiber and luminance (D65 at 200LUX
irradiation for 20 min)

| | | | | | | com- |
|---|---|---|---|---|---|---|
| | Time | Embodi- | Embodi- | Embodi- | Embodi- | parative |
| Item | (min) | ment 1 | ment 2 | ment 3 | ment 4 | example1 |
| Fiber | — | 75D/72F | 75D/72F | 75D/72F | 75D/72F | 75D/72F |
| specification | | | | | | |
| luminance | 2 | 156 | 158 | 157 | 156 | 110 |
| (mcd/m²) | 10 | 66 | 68 | 67 | 66 | 56 |
| | 20 | 52 | 53 | 55 | 54 | 32 |
| | 30 | 32 | 33 | 34 | 33 | 13 |
| | 60 | 15 | 16 | 15 | 15 | 5 |
| Residual | 2→60 | 9.6 | 10.1 | 9.5 | 9.6 | 4.5 |
| luminance % | | | | | | |

TABLE 4
light-storing fiber and luminance (D65 at 25LUX
irradiation for 15 min)

| | | | | | | com- |
|---|---|---|---|---|---|---|
| | Time | Embodi- | Embodi- | Embodi- | Embodi- | parative |
| Item | (min) | ment1 | ment2 | ment3 | ment4 | example1 |
| Fiber | — | 75D/72F | 75D/72F | 75D/72F | 75D/72F | 75D/72F |
| specification | | | | | | |
| luminance | 2 | 52 | 53 | 52 | 53 | 36 |
| (mcd/m²) | 10 | 22 | 23 | 22 | 21 | 56 |
| | 20 | 17 | 18 | 18 | 17 | 19 |
| | 30 | 10 | 11 | 11 | 12 | 4 |
| | 60 | 6 | 6 | 6 | 6 | 2 |
| Residual | 2→60 | 11.5 | 11.3 | 11.5 | 11.3 | 5.5 |
| luminance % | | | | | | |

TABLE 5
light-storing fiber before and after washed

| | | | | | | com- |
|---|---|---|---|---|---|---|
| | | Embodi- | Embodi- | Embodi- | Embodi- | parative |
| Item | Unit | ment1 | ment2 | ment3 | ment4 | example1 |
| Fiber | (D/F) | 75D/72F | 75D/72F | 75D/72F | 75D/72F | 75D/72F |
| specification | | | | | | |
| Initial 2 min | mcd/m² | 156 | 158 | 157 | 156 | 110 |
| luminance | | | | | | |
| before washed | | | | | | |
| Initial 2 min | mcd/m² | 156 | 158 | 157 | 156 | 110 |
| luminance | | | | | | |
| after washed | | | | | | |

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A light-storing fiber with high luminance produced by melt spinning with a light-storing masterbatch, characterized in that the light-storing masterbatch includes the following components, the sum of the components being 100 wt % based on the total amount:
a) 50% to 95 wt % of thermoplastic polymer selected from polyester powder and polyester granules having an intrinsic viscosity (IV) of 0.2 to 2.0;
b) 1% to 30 wt % of modified light-storing powder which is an aluminate doped with rare-earth elements, represented as the general formula M₁₋ₓAl₂O₄·Eu_{Y}N_{Z}; wherein M is Sr, Mg, Ca or Ba, N is Td, Dy, La, Ce, Mn, Sm, Gd, Pr, Lu, Ho, Y, Yb, Tm or Er; and −0.33≤X≤0.6,0.008≤Y≤0.002, 0.002≤Z≤0.005; and
c) 0.01 to 5 wt % of antioxidants;
wherein the light-storing fiber satisfies the following conditions:
(1) after irradiation with a D65 light source at 2001 ux for 20 minutes, the initial luminance can reach 150 mcd/m2 or more;
(2) after irradiation with a D65 light source at 25 LUX for 25 minutes, the initial luminance can reach 50 mcd/m2 or more.

2. The light-storing fiber according to claim 1, wherein the light-storing masterbatch has a pressure rise value less than or equal to 0.5 bar/g.

3. The light-storing fiber according to claim 1, wherein the light-storing fiber has a fiber fineness of 1 to 10 dpf.

4. The light-storing fiber according to claim 3, wherein the light-storing fiber has a core-sheath structure, a core is a light-storing masterbatch, a sheath is a polyester, and a core-sheath ratio is between 40/60 to 60/40.

5. The light-storing fiber according to claim 3, wherein the light-storing fiber has a diameter of 10 to 30 micrometers (μm).

6. The light-storing fiber according to claim 1, wherein the modified light-storing powder contains a silane coupling agent or a phthalate modifier in an amount of 0.1 to 20% by weight based on the total amount of the light-storing powder.

7. The light-storing fiber according to claim 1, wherein the modified light-storing powder contains 3-propenyloxypropyltrimethoxysilane or pyrophosphate titanate in an amount of 1% to 10% by weight based on the total amount of light-storing powder.

8. The light-storing fiber according to claim 1, wherein the thermoplastic polymer has an intrinsic viscosity (IV) of 1.2.

9. The light-storing fiber according to claim 1, wherein the antioxidant is selected from the group consisting of a hindered phenol type antioxidant and a phosphite type antioxidant.

10. The light-storing fiber according to claim 1, wherein the antioxidant is bis(2,6-di-tert-butyl-4-methylphenyl)pentaerythritol diphosphite.
